(19) United States
(12) Patent Application Publication
(10) Pub. No.: US 2011/0297563 A1
(43) Pub. Date: Dec. 8, 2011

(54) METHODS FOR REDUCING RISK

(75) Inventor: Linda SCARAZZINI, Philadelphia, PA (US)

(73) Assignee: SANOFI, Paris (FR)

(21) Appl. No.: 13/211,673

(22) Filed: Aug. 17, 2011

Related U.S. Application Data
(63) Continuation of application No. 12/777,606, filed on May 11, 2010, now abandoned.
(60) Provisional application No. 61/177,409, filed on May 12, 2009.
(60) Provisional application No. 61/223,202, filed on Jul. 6, 2009.

(30) Foreign Application Priority Data
Apr. 22, 2010 (FR) 1053062

(51) Int. Cl. B65D 71/00; G09B 23/28

(52) U.S. Cl. 206/232; 434/262

(57) ABSTRACT

Methods for limiting and controlling the distribution of dronedarone to patients whose use of the drug might present an unacceptable risk.

This application is a continuation of U.S. application Ser. No. 12/777,606, filed May 11, 2010, which claims the benefit of priority of U.S. Provisional Application Nos. 61/177,409, filed May 12, 2009 and 61/223,202, filed Jul. 6, 2009, all of which are incorporated herein by reference; and claims the benefit of French Application No. 1053062, filed Apr. 22, 2010.

This invention relates to methods of reducing the risk of dronedarone use in certain patient populations.

### BACKGROUND

2-n-butyl-3-[4-(3-di-n-butylaminopropoxy)benzoyl]-5-methylsulfonamido-benzofuran, also known as dronedarone, and its pharmaceutically acceptable salts are described in the European patent EP 0 471 609 B1.

Dronedarone is an antiarrhythmic agent effective in the reduction of cardiovascular hospitalization and death in patients with atrial fibrillation or atrial flutter or with a history of atrial fibrillation or atrial flutter, and is sold under the brand name Multaq®

Dronedarone has been shown to be effective for reduction of the risk of cardiovascular hospitalization in patients with atrial fibrillation (AF) or atrial flutter (AFL) or a history of AF or AFL at a dosage of 400 mg twice daily (BID). The safety of dronedarone has been evaluated in a clinical development program that included, as of 12 Mar. 2008, a total of 8276 treated patients/healthy subjects in 55 completed studies. Of these, 4794 patients/healthy subjects received dronedarone.

Patients with the claimed indication of AF/AFL were included in 5 controlled clinical studies representing 88% (6285 patients) of the exposed patient population (7109 patients). Other patient populations, representing 14% (1028 patients) of the exposed patient population, were included in 13 clinical studies in patients with other cardiac conditions and patients with renal and hepatic impairment.

The safety profile of dronedarone 400 mg BID is derived from analysis of the 3282 patients in the 5 AF/AFL studies who were treated with dronedarone 400 mg BID and the 2875 who received placebo. The mean duration of exposure across the 5 studies in the dronedarone 400 mg BID group was 13.5 months, representing total exposure of 3684 patient-years. In the ATHENA study, the maximum follow-up was 30 months.

Assessment of intrinsic factors such as race, gender, and age on incidence of any treatment-emergent adverse events did not suggest any excess of adverse events in a particular subgroup. Discontinuation due to adverse reactions occurred in 11.8% of patients in the dronedarone 400 mg BID group and 7.7% in the placebo-treated group. The most common adverse events causing discontinuation of therapy with dronedarone 400 mg BID were gastrointestinal disorders (3.2% of patients versus 1.8% in the placebo group). The most frequent clinical adverse reactions observed with dronedarone 400 mg BID in these 5 studies were diarrhea, nausea and vomiting, fatigue, asthenia, bradycardia, and rashes. The most frequent investigation abnormalities observed with dronedarone 400 mg BID were QT prolongation and increase in serum creatinine.

Dronedarone is pharmacologically related to the marketed product amiodarone, although with different relative effects on individual ion channels. It was designed with the intent to eliminate the noncardiovascular adverse effects of amiodarone. Adverse reactions known to be associated with amiodarone that are described in the Warnings and Precautions sections of amiodarone labeling (e.g., thyroid effects, interstitial lung disease, hepatic effects, neuropathies, photosensitivity, and corneal deposits) were specifically assessed in the Multaq® clinical program.

The present invention relates to the following identified and potential risk of dronedarone: mortality in patients with severe heart failure (HF) during treatment. The study referred to as ANDROMEDA was conducted in 627 patients with left ventricular dysfunction, hospitalized with symptomatic HF, requiring treatment with a diuretic, who have had within the last month at least 1 episode of dyspnea or fatigue at rest, or on slight exertion. At randomization, only one-fourth had AF at randomization (38% had a history of AF). The study was stopped prematurely due to an observed imbalance of deaths in the dronedarone group [n=25 versus 12 (placebo), p=0.027]. The main reason for death was worsening heart failure. Clinical judgment of the physician should guide the management plan of each patient based on individual benefit/risk assessment.

### SUMMARY OF THE INVENTION

The present invention therefore relates to methods for limiting and controlling the distribution of dronedarone to patients whose use of the drug might present an unacceptable risk. In one aspect of the invention, the methods relate to preventing dronedarone use in patients with NYHA Class IV heart failure or NYHA Class II-III heart failure with recent decompensation requiring hospitalization or referral to a specialized heart failure clinic comprising educating prescribers and patients about increased mortality when dronedarone is used in this patient population.

### DETAILED DESCRIPTION OF THE INVENTION

The term “MULTAQ®,” as used herein, refers to dronedarone HCl.

“AF” and “AFib” mean atrial fibrillation

“AFL” means atrial flutter

BID” means two times a day.

“CHF” mean congestive heart failure.

The term “dronedarone,” solely for the purposes of the present invention, refers to dronedarone or a pharmaceutically acceptable salt thereof. In one aspect of the invention, the pharmaceutically acceptable salt is the hydrochloride salt.

“NYHA” means New York Heart Association.

The methods of the present invention may be used to educate and reinforce the actions and behaviors of patients who are taking dronedarone, as well as prescribers who prescribe the drug and pharmacies who dispense the drug. A variety of educational materials may be employed to ensure proper prescribing, dispensing, and patient compliance according to the methods described herein. For example, a variety of literature and other materials, such as, for example, prescribing information, package inserts, medications guides, physician information sheets, healthcare professional information sheets, medical journal advertisements, product websites, and surveys may describe the risks and benefits of taking dronedarone.

Accordingly, one aspect of the invention is a method of treating a patient with atrial fibrillation or atrial flutter while preventing use of dronedarone in a patient for whom treatment with dronedarone may present an unacceptable risk, said method comprising providing a medication guide to said patient receiving a sample or a prescription of dronedarone.

Another aspect of the invention is a method of distributing dronedarone to a patient in need thereof while preventing use of dronedarone in a patient for whom treatment with dronedarone may present an unacceptable risk, said method comprising providing a medication guide to said patient receiving a sample or a prescription of dronedarone.

A medication guide, according to the present invention, provides information directly to patients regarding the safe use of dronedarone, thus reinforcing information that is conveyed by their prescribing physicians. A medication guide should be written in patient-oriented language and provide information about who should not take dronedarone, symptoms that need to be reported while taking dronedarone, and dosing instructions. The document may also instruct patients to notify their physicians promptly about starting, changing, or stopping any medications. Steps can be taken to ensure that a medication guide is provided each time dronedarone is dispensed to a patient.

One aspect of the invention includes methods of ensuring that a medication guide is provided to each patient receiving a sample or a prescription of dronedarone. In one aspect, the method comprises providing a message on the label of each container or package of dronedarone instructing authorized dispensers to provide a medication guide to each patient to whom the drug is dispensed. Another aspect of the invention comprises providing full prescribing information that includes a medication guide with each package of dronedarone (for example, with each 60-count unit-of-use bottle of dronedarone, e.g., a monthly usual supply). A particular aspect comprises providing additional medication guides for larger bottles, e.g., 180-count and 500-count bottles, for example as follows: a minimum of 3 medication guides can be provided with each 180-count bottle, for example; a minimum of 9 medication guides can be provided with each 500-count bottle, for example.

Medication guides can be made available via prescribers, sales and/or medical representatives, a product website or through a distributor's medical information services department.

Another aspect of the invention is an article of manufacture comprising:
a) a packaging material;
b) dronedarone or a pharmaceutically acceptable salt thereof; and
c) a medication guide.

Another aspect of the invention is a package comprising dronedarone or a pharmaceutically acceptable salt thereof and a medication guide.

In one aspect, the medication guide comprises at least one message selected from the group consisting of:
a. dronedarone is not for people with severe heart failure;
b. dronedarone should not be taken by a patient with severe heart failure:
   i. where any physical activity causes shortness of breath or the patient has shortness of breath while at rest or after a small amount of exercise; and
   ii. if the patient was hospitalized with heart failure within the last month;
c. the patient's doctor should be contacted if the patient has any of the symptoms selected from the group consisting of:
   i. shortness of breath or wheezing at rest;
   ii. wheezing, chest tightness or coughing up frothy sputum at rest, nighttime or after minor exercise;
   iii. trouble sleeping or waking up at night because of breathing problems;
   iv. using more pillows to prop up at night to breath more easily;
   v. gaining more than 5 pounds quickly; and
   vi. increasing swelling of feet or legs.

In another aspect, the medication guide comprises at least one message selected from the group consisting of:
a. a patient should not take dronedarone if the patient has severe heart failure or has recently been in the hospital for heart failure;
b. a patient should not take dronedarone if the patient has severe liver problems;
c. a patient should not take dronedarone if the patient takes certain medications that can change the amount of dronedarone that gets into the patient's body;
d. a patient should not take dronedarone with a medication selected from the group consisting of nefazodone, ritonavir, ketoconazole, itraconazole, voriconazole, telithromycin, clarithromycin, and cyclosporine;
e. a patient should not take dronedarone if the patient takes certain medications that can lead to a dangerous abnormal heartbeat selected from the group consisting:
   i. some medicines for mental illness called phenothiazines;
   ii. some medicines for depression called tricyclic antidepressants;
   iii. some medicines for abnormal heart rhythm or fast heartbeat; and
   iv. some medicines for bacterial infection;
f. a patient should not take dronedarone if the patient is pregnant or plans to become pregnant;
g. a patient should not take dronedarone if the patient is breast-feeding or plans to breast feed.

In another aspect, the medication guide comprises at least one message selected from the group consisting of:
a. a patient should tell his or her doctor and pharmacist if the patient takes medicine for high blood pressure; chest pain, or other heart conditions;
b. a patient should tell his or her doctor and pharmacist if the patient takes a statin medicine to lower blood cholesterol;
c. a patient should tell his or her doctor and pharmacist if the patient takes medicine for tuberculosis;
d. a patient should tell his or her doctor and pharmacist if the patient takes medicine for seizures;
e. a patient should tell his or her doctor and pharmacist if the patient takes medicine for organ transplant;
f. a patient should tell his or her doctor and pharmacist if the patient takes an herbal supplement called St. John's wort.

In another aspect, the medication guide comprises at least one message to a patient selected from the group consisting of:
a. take dronedarone exactly as the doctor prescribes;
b. take dronedarone two times a day with food;
c. do not stop taking dronedarone even if you are feeling well for a long time;
d. if you miss a dose, wait and take your next dose at your regular time;
e. do not take 2 doses at the same time;
f. do not try to make up for a missed dose; and
g. do not drink grapefruit juice while you take dronedarone.

Another method of reducing the risk of dronedarone use in certain patient populations according to the present invention is to communicate to healthcare providers the risks associated with the use of dronedarone and the safe and appropriate prescribing information.

Accordingly, one aspect of the invention is distributing a physician information sheet or a healthcare professional information sheet to a healthcare professional. According to the present invention, healthcare providers include cardiologists, electrophysiologists, hospitalists, internal medicine and family practice physicians who regularly prescribe antiarrhythmic agents, as well as relevant professional societies. Healthcare providers can also include nurse practitioners and physician assistants working in offices of these physicians.

A physician information sheet or healthcare professional information sheet provides specific details of importance to physicians. In one aspect of the invention, the physician Information sheet states the contraindication for dronedarone use in patients with NYHA Class IV heart failure or NYHA Class II-III heart failure with recent decompensation requiring hospitalization. In another aspect, the physician information sheet contains a message comprising specific key points to consider when initiating, counseling, and monitoring patients on dronedarone therapy.

One aspect of the invention comprises providing healthcare professionals with a physician information sheet or a health care professional information sheet. A particular aspect comprises distributing the physician information sheet or health care professional information sheet through hardcopy mailings. In addition, this information can be distributed through electronic communication (Health Care Notification Network [HCNN]) and made available on a dronedarone product website.

In one aspect, the physician information sheet or a health care professional information sheet comprises at least one message selected from the group consisting of:
a. dronedarone is an antiarrhythmic drug indicated to reduce the risk of cardiovascular hospitalization in patients with paroxysmal or persistent atrial fibrillation (AFib) or atrial flutter (AFL), with a recent episode of AFib/AFL and associated cardiovascular risk factors (i.e., age>70, hypertension, diabetes, prior cerebrovascular accident, left atrial diameter≧50 mm or left ventricular ejection fraction [LVEF]<40%), who are in sinus rhythm or who will be cardioverted;
b. dronedarone is contraindicated in patients with NYHA Class IV heart failure, or NYHA Class II-III heart failure with a recent decompensation requiring hospitalization or referral to a specialized heart failure clinic; and
c. in a placebo-controlled study in patients with severe heart failure requiring recent hospitalization or referral to a specialized heart failure clinic for worsening symptoms (the ANDROMEDA Study), patients given dronedarone had a greater than two-fold increase in mortality; such patients should not be given dronedarone.

In another aspect, the physician information sheet or health care professional information sheet comprises at least one message selected from the group consisting of:
a. dronedarone is contraindicated with the coadministration of strong CYP3A4 inhibitors, medicinal products inducing Torsade de Pointes, or Class I or III antiarrhythmic agents;
b. dronedarone is contraindicated in patients with second- or third-degree atrioventricular block, sick sinus syndrome (except when used in conjunction with a functioning pacemaker), or bradycardia of <50 bpm;
c. dronedarone is contraindicated in patients having QTc Bazett≧500 ms or PR interval>280 ms;
d. dronedarone is contraindicated in patients with severe hepatic impairment; and
e. dronedarone is contraindicated in pregnant or nursing mothers.

Another method for reducing the risk of inappropriate use of dronedarone according to the present invention includes a method of treating a patient comprising initiating dronedarone in appropriate patients; counseling patients to report changes in their symptoms and their medications; checking patients for changes in their symptoms; and performing certain lab tests.

The step of initiating dronedarone in appropriate patients may include one or more of: screening patients for severity and stability of heart failure; not initiating dronedarone in patients with NYHA Class IV heart failure or NYHA Class II-III heart failure with recent decompensation requiring hospitalization or referral to a specialized heart failure clinic; initiating treatment in an outpatient or an inpatient setting, discontinuing use of Class I or Class III antiarrhythmic therapies; and optionally adjusting the dosage of certain cardiovascular medications.

The step of counseling patients to report changes in their symptoms and their medications may include one or more of: advising patients to consult a physician if they develop signs or symptoms of worsening heart failure such as weight gain, dependent edema, and/or increasing shortness of breath; advising patients that dronedarone should not be taken with certain other medications and to consult with their physicians before starting any new drugs as the dosage of certain cardiovascular medications may need to be adjusted; and referring patients to a medication guide and address any additional questions.

Checking patients for changes in their symptoms or certain lab tests may include one or more of: observing patients regularly for signs or symptoms of heart failure that may require additional treatment and/or dronedarone discontinuation; and being aware that within a week, dronedarone causes a small change in serum creatinine that does not reflect a change in underlying renal function.

Accordingly, in one aspect, the physician information sheet or health care professional information sheet comprises at least one message to a healthcare professional selected from the group consisting of:
a. initiate dronedarone in appropriate patients;
   i. screen patients for severity and stability of heart failure; dronedarone should not be initiated in patients with NYHA Class IV heart failure or NYHA Class II-III heart failure with recent decompensation requiring hospitalization or referral to a specialized heart failure clinic;
   ii. treatment may be initiated in an outpatient or an inpatient setting;
   iii. discontinue use of other Class I or Class III antiarrhythmic therapies;
   iv. the dosage of certain cardiovascular medications may need to be adjusted and certain laboratory test changes may occur;
b. counsel patients to report changes in their symptoms and their medications;
   i. advise patients to consult a physician if they develop signs or symptoms of worsening heart failure such as weight gain, dependent edema, and/or increasing shortness of breath;
   ii. advise patients that dronedarone should not be taken with certain other medications and to consult with their physicians before starting any new drugs as the dosage of certain cardiovascular medications may need to be adjusted;
   iii. refer patients to the medication guide and address any additional questions;
c. check patients for changes in their symptoms or certain lab tests;
   i. observe patients regularly for signs and symptoms of heart failure that may require additional treatment and/or dronedarone discontinuation; and
   ii. be aware that within a week, dronedarone causes a small change in serum creatinine that does not reflect a change in underlying renal function.

In another aspect, the physician information sheet or health care professional information sheet comprises a message informing the reader to use clinical judgment to guide the management of each patient with developing or worsening heart failure during treatment, based on individual benefit/risk assessment; and consider the suspension or discontinuation of dronedarone therapy.

In another aspect, the physician information sheet or a health care professional information sheet comprises a message informing a healthcare professional that dronedarone is contraindicated in patients with NYHA Class IV heart failure, or NYHA Class II-III heart failure with a recent decompensation requiring hospitalization or referral to a specialized heart failure clinic.

The physician information sheet can be delivered, for example by mail, to U.S. cardiologists (including electrophysiologists), hospitalists, internal medicine and family practice physicians who regularly prescribe antiarrhythmic drugs (AAD), as reported by IMS Health, and relevant professional societies.

Another aspect of the invention comprises providing evidence-based data about dronedarone in response to unsolicited requests from healthcare professionals. The data can be provided in a medication guide, on a package insert, or in a physician information sheet or a health care professional information sheet

Another method for reducing the risk of dronedarone use in certain patient population comprises assessing healthcare professional knowledge and understanding of the risk of dronedarone use in certain patient populations, i.e, patients with NYHA Class IV heart failure or NYHA Class II-III heart failure with recent decompensation requiring hospitalization.

In one aspect, the assessment comprises evaluating healthcare professional understanding of appropriate patient populations for utilization of dronedarone, patient understanding of dronedarone risks, and need for program improvements or modifications, as appropriate. In a particular aspect, the physician information sheet is updated in view of the assessment.

Periodic surveys can be conducted, for example, in samples of dronedarone prescribers.

In one aspect, the survey can assess physicians for their knowledge and understanding of appropriate patient selection, monitoring, and management, specifically avoiding use in patients with NYHA Class IV heart failure or NYHA Class II-III heart failure with recent decompensation requiring hospitalization.

In another aspect, the survey measures physician ability to recall and apply criteria for selecting, monitoring, and managing patients appropriate for dronedarone.

The results of the survey are preferably entered into a computer readable storage medium. Once entered into the computer readable storage medium, the prescriber, manufacturer and/or distributor of dronedarone may be able to ascertain if healthcare providers are aware of the safe and appropriate prescribing of dronedarone.

Another method for reducing the risk of dronedarone use in certain patient populations comprises assessing patient knowledge and understanding of the risk of dronedarone use. A particular aspect comprises surveying patients to monitor the effectiveness of the interventions (such as, for example, the medication guide and physician consultation) in educating patients on the safe and appropriate use of dronedarone.

Periodic surveys can be conducted, for example, in representative samples of dronedarone patients to assess the effectiveness of a medication guide by assessing knowledge and understanding of the safe and appropriate use of dronedarone and pharmacist compliance with distribution of the medication guide.

In one aspect, the survey can assess patients for their knowledge and understanding of the risks of dronedarone use in heart failure and heart failure symptoms.

The survey can include a questionnaire assessing whether patients can correctly identify medication risks and messages from the medication guide. Additional questions can assess by what means the patients received medication guide content in order to assess compliance with medication guide distribution by pharmacists.

The results of the patient survey are preferably entered into a computer readable storage medium. Once entered into the computer readable storage medium, the prescriber, manufacturer and/or distributor of dronedarone may be able to identify the level of risk associated with administering dronedarone in one or more subpopulation of patients.

Another method for reducing the risk of dronedarone use in certain patient population comprises performing a drug utilization study.

A drug utilization study is a postmarketing epidemiologic study characterizing the dronedarone patient population and estimating the proportion of patients with worsening congestive heart failure or hospitalized for congestive heart failure within a month prior to dronedarone initiation.

In one aspect, the study further comprises characterizing dronedarone users according to one or more of: age on the first dronedarone prescription date; gender; and AF/AFL diagnosis, any CHF diagnosis, and other co-morbid conditions (diabetes, hypertension, stroke, and myocardial infarction) at baseline. AF/AFL can be defined as patients with at least one diagnosis over a period of one year on or before the date of dronedarone prescription.

In one aspect, the study further comprises identifying patients with worsening CHF or hospitalized for CHF within the last month among any dronedarone users. In one aspect, identifying the patients with worsening CHF and/or hospitalized for CHF within the last month comprises:
a. identifying patients with a diagnosis of heart failure (ICD-9 codes: 428.X);
b. of the patients who are identified during step one, selecting those who are hospitalized for heart failure based on admission or discharge diagnosis within 30 days prior to dronedarone treatment;
c. of the patients who are identified during step one and are not meeting the criteria for step two, selecting those who have a diagnosis of heart failure and meet any one of the following criteria within 30 days prior to dronedarone treatment: 1) change from oral to IV diuretics or 2) being on IV diuretics.

What is claimed is:

1. A method of treating a patient with atrial fibrillation or atrial flutter while preventing use of dronedarone in a patient for whom treatment with dronedarone may present an unacceptable risk, said method comprising providing a medication guide to said patient receiving a sample or a prescription of dronedarone.

2. The method according to claim 1, wherein the medication guide comprises at least one message selected from the group consisting of:
a. dronedarone is not for people with severe heart failure;
b. dronedarone should not be taken by a patient with severe heart failure:
i. where any physical activity causes shortness of breath or the patient has shortness of breath while at rest or after a small amount of exercise; and
ii. if the patient was hospitalized with heart failure within the last month;
c. the patient's doctor should be contacted if the patient has any of the symptoms selected from the group consisting of:
i. shortness of breath or wheezing at rest;
ii. wheezing, chest tightness or coughing up frothy sputum at rest, nighttime or after minor exercise;
iii. trouble sleeping or waking up at night because of breathing problems;
iv. using more pillows to prop up at night to breath more easily;
v. gaining more than 5 pounds quickly; and
vi. increasing swelling of feet or legs.

3. The method according to claim 1, wherein the medication guide comprises at least one message selected from the group consisting of:
a. a patient should not take dronedarone if the patient has severe heart failure or has recently been in the hospital for heart failure;
b. a patient should not take dronedarone if the patient has severe liver problems;
c. a patient should not take dronedarone if the patient takes certain medications that can change the amount of dronedarone that gets into the patient's body;
d. a patient should not dronedarone with a medication selected from the group consisting of nefazodone, ritonavir, ketoconazole, itraconazole, voriconazole, telithromycin, clarithromycin, and cyclosporine;
e. a patient should not take dronedarone if the patient takes certain medications that can lead to a dangerous abnormal heartbeat selected from the group consisting:
i. some medicines for mental illness called phenothiazines;
ii. some medicines for depression called tricyclic antidepressants;
iii. some medicines for abnormal heart rhythm or fast heartbeat; and
iv. some medicines for bacterial infection;
f. a patient should not take dronedarone if the patient is pregnant or plans to become pregnant;
g. a patient should not take dronedarone if the patient is breast-feeding or plans to breast feed.

4. The method according to claim 1, wherein the medication guide comprises at least one message selected from the group consisting of:
a. a patient should tell his or her doctor and pharmacist if the patient takes medicine for high blood pressure, chest pain, or other heart conditions;
b. a patient should tell his or her doctor and pharmacist if the patient takes a statin medicine to lower blood cholesterol;
c. a patient should tell his or her doctor and pharmacist if the patient takes medicine for tuberculosis;
d. a patient should tell his or her doctor and pharmacist if the patient takes medicine for seizures;
e. a patient should tell his or her doctor and pharmacist if the patient takes medicine for organ transplant;
f. a patient should tell his or her doctor and pharmacist if the patient takes an herbal supplement called St. John's wort.

5. The method according to claim 1, wherein the medication guide comprises at least one message to a patient selected from the group consisting of:
a. take dronedarone exactly as the doctor prescribes;
b. take dronedarone two times a day with food;
c. do not stop taking dronedarone even if you are feeling well for a long time;
d. if you miss a dose, wait and take your next dose at your regular time;
e. do not take 2 doses at the same time;
f. do not try to make up for a missed dose; and
g. do not drink grapefruit juice while you take dronedarone.

6. An article of manufacture comprising:
a. a packaging material;
b. dronedarone or a pharmaceutically acceptable salt thereof; and
c. a medication guide.

7. A package comprising dronedarone or a pharmaceutically acceptable salt thereof and a medication guide.

8. The package according to claim 7, wherein the medication guide comprises at least one message selected from the group consisting of:
a. dronedarone is not for people with severe heart failure;
b. dronedarone should not be taken by a patient with severe heart failure:
i. where any physical activity causes shortness of breath or the patient has shortness of breath while at rest or after a small amount of exercise; and
ii. if the patient was hospitalized with heart failure within the last month;
c. the patient's doctor should be contacted if the patient has any of the symptoms selected from the group consisting of:
i. shortness of breath or wheezing at rest;
ii. wheezing, chest tightness or coughing up frothy sputum at rest, nighttime or after minor exercise;
iii. trouble sleeping or waking up at night because of breathing problems;
iv. using more pillows to prop up at night to breath more easily;
v. gaining more than 5 pounds quickly; and
vi. increasing swelling of feet or legs.

9. The package according to claim 7, wherein the medication guide comprises at least one message selected from the group consisting of:
a. a patient should not take dronedarone if the patient has severe heart failure or has recently been in the hospital for heart failure;
b. a patient should not take dronedarone if the patient has severe liver problems;
c. a patient should not take dronedarone if the patient takes certain medications that can change the amount of dronedarone that gets into the patient's body;
d. a patient should not take dronedarone with a medication selected from the group consisting of nefazodone, ritonavir, ketoconazole, itraconazole, voriconazole, telithromycin, clarithromycin, and cyclosporine;
e. a patient should not take dronedarone if the patient takes certain medications that can lead to a dangerous abnormal heartbeat selected from the group consisting:
i. some medicines for mental illness called phenothiazines;
ii. some medicines for depression called tricyclic antidepressants;
iii. some medicines for abnormal heart rhythm or fast heartbeat; and
iv. some medicines for bacterial infection;
f. a patient should not take dronedarone if the patient is pregnant or plans to become pregnant;
g. a patient should not take dronedarone if the patient is breast-feeding or plans to breast feed.

10. The package according to claim 7, wherein the medication guide comprises at least one message selected from the group consisting of:
a. a patient should tell his or her doctor and pharmacist if the patient takes medicine for high blood pressure, chest pain, or other heart conditions;
b. a patient should tell his or her doctor and pharmacist if the patient takes a statin medicine to lower blood cholesterol;
c. a patient should tell his or her doctor and pharmacist if the patient takes medicine for tuberculosis;
d. a patient should tell his or her doctor and pharmacist if the patient takes medicine for seizures;
e. a patient should tell his or her doctor and pharmacist if the patient takes medicine for organ transplant; and
f. a patient should tell his or her doctor and pharmacist if the patient takes an herbal supplement called St. John's wort.

11. The package according to claim 7, wherein the medication guide comprises at least one message to a patient selected from the group consisting of:
a. take dronedarone exactly as the doctor prescribes;
b. take dronedarone two times a day with food;
c. do not stop taking dronedarone even if you are feeling well for a long time;
d. if you miss a dose, wait and take your next dose at your regular time;
e. do not take 2 doses at the same time;
f. do not try to make up for a missed dose; and
g. do not drink grapefruit juice while you take dronedarone.

12. A method of preventing dronedarone use in patients with NYHA Class IV heart failure or NYHA Class II-III heart failure with recent decompensation requiring hospitalization or referral to a specialized heart failure clinic, said method comprising educating prescribers about increased mortality when dronedarone is used in these patients.

13. The method according to claim 12, comprising providing healthcare professionals with a physician information sheet or a health care professional information sheet.

14. The method according to claim 13, wherein the physician information sheet or health care professional information sheet comprises at least one message selected from the group consisting of:
a. dronedarone is an antiarrhythmic drug indicated to reduce the risk of cardiovascular hospitalization in patients with paroxysmal or persistent atrial fibrillation (AFib) or atrial flutter (AFL), with a recent episode of AFib/AFL and associated cardiovascular risk factors (i.e., age>70, hypertension, diabetes, prior cerebrovascular accident, left atrial diameter≧50 mm or left ventricular ejection fraction [LVEF]<40%), who are in sinus rhythm or who will be cardioverted;
b. dronedarone is contraindicated in patients with NYHA Class IV heart failure, or NYHA Class II-III heart failure with a recent decompensation requiring hospitalization or referral to a specialized heart failure clinic; and
c. in a placebo-controlled study in patients with severe heart failure requiring recent hospitalization or referral to a specialized heart failure clinic for worsening symptoms (the ANDROMEDA Study), patients given dronedarone had a greater than two-fold increase in mortality; such patients should not be given dronedarone.

15. The method according to claim 13, wherein the physician information sheet or health care professional information sheet comprises at least one message selected from the group consisting of:
a. dronedarone is contraindicated with the coadministration of strong CYP3A4 inhibitors, medicinal products inducing Torsade de Pointes, or Class I or III antiarrhythmic agents;
b. dronedarone is contraindicated in patients with second- or third-degree atrioventricular block, sick sinus syndrome (except when used in conjunction with a functioning pacemaker), or bradycardia of <50 bpm;
c. dronedarone is contraindicated in patients having QTc Bazett≧500 ms or PR interval>280 ms;
d. dronedarone is contraindicated in patients with severe hepatic impairment; and
e. dronedarone is contraindicated in pregnant or nursing mothers.

16. The method according to claim 13, wherein the physician information sheet or health care professional information sheet comprises at least one message to a healthcare professional selected from the group consisting of:
a. initiate dronedarone in appropriate patients;
i. screen patients for severity and stability of heart failure; dronedarone should not be initiated in patients with NYHA Class IV heart failure or NYHA Class II-III heart failure with recent decompensation requiring hospitalization or referral to a specialized heart failure clinic;
ii. treatment may be initiated in an outpatient or an inpatient setting;
iii. discontinue use of other Class I or Class III antiarrhythmic therapies;
iv. the dosage of certain cardiovascular medications may need to be adjusted and certain laboratory test changes may occur;
b. counsel patients to report changes in their symptoms and their medications;
i. advise patients to consult a physician if they develop signs or symptoms of worsening heart failure such as weight gain, dependent edema, and/or increasing shortness of breath;
ii. advise patients that dronedarone should not be taken with certain other medications and to consult with their physicians before starting any new drugs as the dosage of certain cardiovascular medications may need to be adjusted;
iii. refer patients to the medication guide and address any additional questions;
c. check patients for changes in their symptoms or certain lab tests;
i. observe patients regularly for signs and symptoms of heart failure that may require additional treatment and/or dronedarone discontinuation; and
ii. be aware that within a week, dronedarone causes a small change in serum creatinine that does not reflect a change in underlying renal function.
